(19) United States
(12) Patent Application Publication
(10) Pub. No.: US 2023/0316246 A1
(43) Pub. Date: Oct. 5, 2023

(54) BANKING PROCESSING APPARATUS AND METHOD, AND REMOTE COUNSELING SERVICE SYSTEM INCLUDING SAME

(71) Applicant: HYOSUNG TNS INC., Seoul (KR)

(72) Inventors: Ki Hang LEE, Namyangju-si (KR); Jin Hyeon KANG, Seoul (KR); Myeong-Won SEO, Seongnam-si (KR); Young Jin YOON, Seoul (KR); Tae Ho YOON, Uijeongbu-si (KR); Joo Yong LEE, Seoul (KR)

(21) Appl. No.: 18/207,968

(22) Filed: Jun. 9, 2023

Related U.S. Application Data
(63) Continuation of application No. PCT/KR2021/000597, filed on Jan. 15, 2021.

(30) Foreign Application Priority Data
Dec. 11, 2020 (KR) 10-2020-0173773

(51) Int. Cl. G06Q 20/10; H04N 7/14; G06F 3/0482

(52) U.S. Cl. CPC G06Q 20/1085; H04N 7/141; G06F 3/0482

(57) ABSTRACT

A banking processing apparatus of an embodiment comprises an output unit including a display device; an input unit configured to determine a user input by a user; a memory; and a processor, wherein the processor is configured to generate a first graphic user interface (GUI) for processing at least one banking service and output the first GUI on the output unit; determine whether the user input on the first GUI is occurred and determine a time at which the user input on the first GUI is occurred; establish a session for a video call with a customer service representative (CSR) terminal and process the video call through the session, if the time at which the user input on the first GUI is occurred is within predetermined business hours; and generate a second GUI for processing at least one banking automation task and output the second GUI on the output unit, if the time at which the user input on the first GUI is occurred is out of the predetermined business hours.

### TECHNICAL FIELD

Embodiments relate to a banking processing apparatus and method capable of non-face-to-face consultation with customers.

### BACKGROUND ART

In general, due to the continuous development of information and communication technology, financial transactions that have conventionally been made through face-to-face authentication have recently been transferred to non-face-to-face financial transactions using non-face-to-face authentication based on wired communication networks, and the amount of financial transactions through internet banking, among the above-mentioned non-face-to-face financial transactions, currently reaches tens of trillions of won per day.

A counselor resides in a bank, but may be absent due to toilet, vacation, or lunch, and accordingly, it is difficult to utilize the seat occupied by the counselor.

That is, in the case of a conventional counseling service method, a limited working environment and difficult supply and demand of counseling personnel are burdened with a lot of operating expenses.

Therefore, with the recent development of information and communication technology, the penetration rate of smartphones is very high and many financial institutions provide customer center services through smartphone applications.

Customer center services through a smartphone application also provide services for menus with high frequency of use among menus provided by an ARS system and have advantages in terms of time and cost compared to existing customer center service methods.

However, customer center services through a smartphone application can only perform simple inquiries, and it is difficult to correctly satisfy customer needs, such as counseling through a counselor. In addition, as the amount of financial task increases in order to meet customer needs, applications of counselor's terminals need to be modified to add new functions or to completely change programs, which causes a problem in that development and replacement costs are considerable.

### DISCLOSURE

### Technical Problem

In order to solve the above problems, an object of embodiments is to provide a remote counseling service system and method, a computer-readable recording medium, and a computer program capable of non-face-to-face banking.

### Technical Solution

In accordance with an aspect of the present disclosure, there is provided a banking processing apparatus, the apparatus may comprise: an output unit including a display device; an input unit configured to determine a user input by a user; a memory; and a processor executing one or more instructions stored in the memory, wherein the instructions, when executed by the processor, cause the processor to generate a first graphic user interface (GUI) for processing at least one banking service and output the first GUI on the output unit; determine whether the user input on the first GUI is occurred and determine a time at which the user input on the first GUI is occurred; establish a session for a video call with a customer service representative (CSR) terminal and process the video call through the session, if the time at which the user input on the first GUI is occurred is within predetermined business hours; and generate a second GUI for processing at least one banking automation task and output the second GUI on the output unit, if the time at which the user input on the first GUI is occurred is out of the predetermined business hours.

The second GUI may include at least one menu corresponding to each of at least one banking automation task that is able to be processed without a customer service representative (CSR).

The at least one banking automation task may include at least one of account opening task, document application task, and card issuance task.

The processor may be configured to communicate with an ATM (Automated Teller Machine), and control the ATM to perform the banking automation task requested by the user.

In accordance with another aspect of the present disclosure, there is provided a banking processing method executed by a processor included in a banking processing apparatus, the method may comprise: generating a first graphic user interface (GUI) for processing at least one banking service and outputting the first GUI on an output unit including a display device; determining whether a user input on the first GUI is occurred through an input unit configured to determine the user input by a user, and determining a time at which the user input on the first GUI is occurred; establishing a session for a video call with a customer service representative (CSR) terminal and processing the video call through the session, if the time at which the user input on the first GUI is occurred is within predetermined business hours; and generating a second GUI for processing at least one banking automation task and outputting the second GUI on the output unit, if the time at which the user input on the first GUI is occurred is out of the predetermined business hours.

The first GUI may include at least one menu corresponding to the at least one banking service, the banking processing method may include determining whether the at least one banking service corresponding to the at least one menu selected by the user is not required to consult with the CSR when the at least one menu corresponding to the at least one banking service is selected by the user; and generating the second GUI for processing at least one banking automation task and outputting the second GUI on the output unit, if the at least one banking service corresponding to the at least one menu selected by the user is not required to consult with the CSR and the time at which the user input on the first GUI is occurred is within the predetermined business hours.

In accordance with another aspect of the present disclosure, there is provided a remote counseling service system, the system may comprise: a banking host; a customer service representative (CSR) terminal connected to the banking host; a digital desk apparatus including an output unit including a display device, an input unit configured to determine a user input by a user, a first memory; and a first processor; and a digital desk server including a second memory and a second processor. Wherein the first processor may be configured to execute one or more instructions stored in the first memory, wherein the instructions, when executed by the first processor, cause the first processor to generate a first graphic user interface (GUI) for processing at least one banking service and output the first GUI on the output unit, determine whether the user input on the first GUI is occurred and determine a time at which the user input on the first GUI is occurred, determine whether the time at which the user input on the first GUI is occurred is within predetermined business hours, establish a session for a video call with the CSR terminal and process the video call through the session, and generate a second GUI for inputting a data requested by a CSR and display the second GUI on the output unit. Wherein the second processor may be configured to execute one or more instructions stored in the second memory, wherein the instructions, when executed by the second processor, cause the second processor to establish the session for the video call between the CSR terminal and the digital desk apparatus if the time at which the user input on the first GUI is occurred is within the predetermined business hours. Wherein the first processor of the digital desk apparatus is configured to generate a third GUI for processing at least one banking automation task and output the third GUI on the output unit, if the time at which the user input on the first GUI is occurred is out of the predetermined business hours.

The second processor of the digital desk server may be configured to: transmit a counseling request message to the CSR terminals based on a type of the at least one banking service requested by the user, receive a counseling response message from at least one of the CSR terminals, and determine at least one of the CSR terminals to be connected to the digital desk apparatus based on a time at which the counseling response message is received.

### Advantageous Effects

The embodiments have an effect of improving the customer's task processing efficiency by controlling a task processing method differently depending on business hours of a bank.

In addition, the embodiments have an effect of more efficiently processing a customer's task by directly accessing a bank host using a second AP.

Furthermore, the embodiments have an effect of implementing a remote counseling service system more conveniently by separately providing a device for controlling images.

### DESCRIPTION OF DRAWINGS

FIG. 1 is a block diagram showing a remote counseling service system according to a first embodiment.

FIG. 2 is a diagram showing a configuration of a digital desk apparatus.

FIG. 3 is a diagram showing a remote counseling service method according to the first embodiment.

FIG. 4 is a block diagram showing a remote counseling service system according to a second embodiment.

FIG. 5 is a block diagram showing a remote counseling service system according to a third embodiment.

### MODE FOR DISCLOSURE

Hereinafter, embodiments will be described in detail with reference to the drawings.

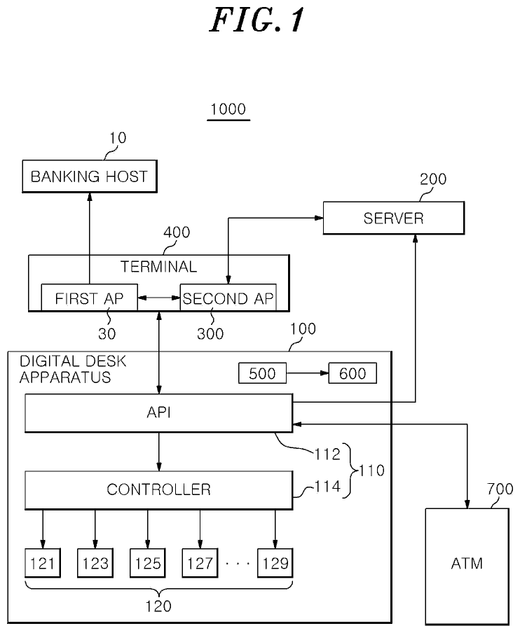

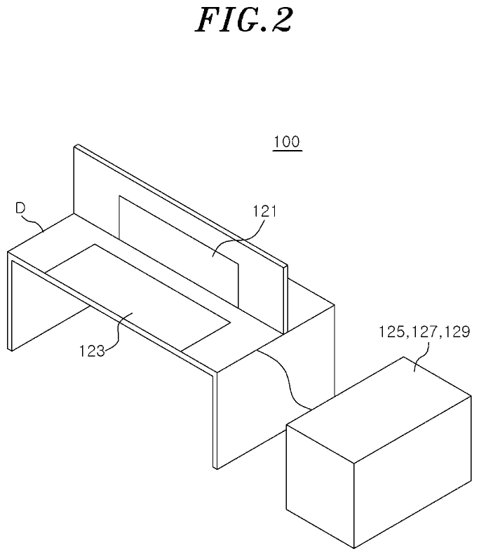

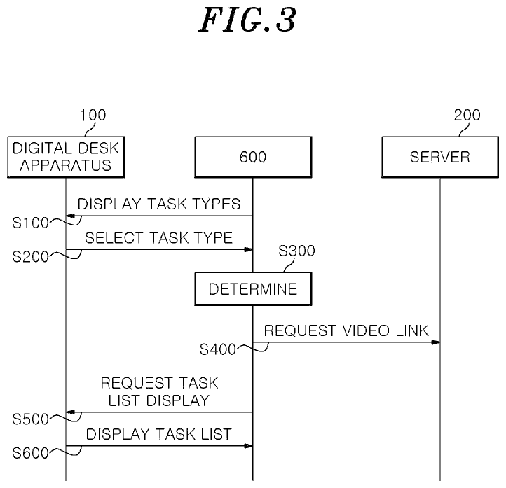

FIG. 1 is a block diagram showing a remote counseling service system according to a first embodiment, FIG. 2 is a diagram showing a configuration of a digital desk apparatus, and FIG. 3 is a diagram showing a remote counseling service method according to the first embodiment.

Referring to FIG. 1, the remote counseling service system according to the first embodiment may include a customer service representative (CSR) terminal 400 connected to a banking host 10, a digital desk apparatus 100 having a counselor connection determination unit 500, and a digital desk server 200. Here, the digital desk server 200 may be installed on the side of a call center, but embodiments are not limited thereto.

The CSR terminal 400 may be connected to the banking host 10. The CSR terminal 400 may perform tasks related to banking service under the control of a counselor. A first application processor (AP) 30 may be included in the CSR terminal 400 to perform communication with the banking host 10.

The CSR terminal 400 may include a second AP 300. The second AP 300 may communicate with the first AP 30. The second AP 300 may receive information from the digital desk apparatus 100. The second AP 300 may communicate with the digital desk server 200.

The digital desk apparatus 100 may include a control unit 110 and an output means 120. The control unit 110 may include an application program interface (API) 112 and a controller 114. The API 112 may perform communication with the second AP 300. The API 112 may receive a video link request from the second AP 300. The controller 114 may establish a video link through a display unit 121 provided in the digital desk apparatus 100, for example, a monitor. Herein, the digital desk apparatus 100 may be a banking processing apparatus for processing banking services.

As shown in FIG. 2, the digital desk apparatus 100 may include a desk D and a plurality of output means 120 controlled by the control unit 110.

The desk D may include a lower plate shaped like a desk and an upper plate disposed between a customer and a counselor, but the shape is not limited thereto.

The output means 120 may include the display unit 121, a touch input unit 123, a scanner 125, a pin pad 127, a printer 129, and the like. The display unit 121 may include a monitor or a transparent display. The display unit 121 may be installed on the upper plate of the desk D and disposed between a customer and a counselor. Two or more image displays 121 may be provided, and the number of image displays is not limited. Here, the upper plate of the desk D may be formed from a transparent acrylic plate and can support the display unit 121.

The touch input unit 123 may be formed on the upper plate of the desk D where a customer is to be seated. The touch input unit 123 may receive touch input of a customer. The touch input unit 123 may receive touch input of a customer selected on a screen on which financial information presented by a counselor is displayed.

The location where the touch input unit 123 is disposed is not limited, but it is effective to form the touch input unit 123 at a distance where a customer's hand can reach. The touch input unit 123 may be a tablet that is not fixed to the desk D and is connected to the desk D through a separate connecting link, but the type is not limited.

The scanner 125, the pin pad 127, and the printer 129 may be disposed on one side of the desk D, and operations thereof may be controlled by the control unit 110.

Referring back to FIG. 1, the digital desk apparatus 100 may include the counselor connection determination unit 500. The counselor connection determination unit 500 may receive a touch input of a customer.

The counselor connection determination unit 500 may determine whether a time at which the touch input of the customer is occurred is within business hours or out of the business hours.

The digital desk apparatus 100 may include a task controller 600.

The task controller 600 may control the digital desk apparatus 100 to process banking automation tasks.

Upon determining that the time at which the touch input of the customer is occurred is within the business hours, the task controller 600 may transmit a signal for connection with a counselor to the digital desk server 200.

In addition, the task controller 600 may determine whether or not a banking service task corresponding to the touch input of the customer is required for counseling with a counselor even if it is determined that the time at which the touch input of the customer is occurred is within the business hours. For example, if the banking service task corresponding to the touch input of the customer is not required for counseling with the counselor, the task controller 600 may perform the task without a counselor.

In addition, the task controller 600 may establish a video link between a counselor terminal and the customer if the time at which the customer requests counseling is within the business hours, and may control the task to be processed through a task automation process if the time is out of the business hours.

Herein, the task automation process may be a process in which the digital desk apparatus 100 switches to an automated teller machine (ATM) 700 and aids the customer in perform banking without a counselor when the time at which the customer requests counseling is out of counselor's business hours.

That is, after switching to the ATM 700, a list of financial transactions that can be processed without a counselor can be displayed through the image display, and the customer can check available financial transactions and then perform banking by himself/herself.

The digital desk server 200 may transmit a counseling request to counselors suitable for counseling of the customer based on the type of the banking service task corresponding to the touch input of the customer. The digital desk server 200 may determine a plurality of counselors capable of processing the banking service task corresponding to the touch input of the customer and transmit a counseling request to a plurality of CSR terminals 400.

When counselors capable of consulting with the customer among the plurality of counselors transmit counseling acknowledgement information to the digital desk server 200 through their CSR terminals 400, the digital desk server 200 may determine a counselor who will consult with the customer based on the first received counseling acknowledgement information. The digital desk server 200 may transmit information on the finally determined counselor to the second AP 300.

The second AP 300 may control the CSR terminal 400 and the display unit 121 disposed on the digital desk apparatus 100 based on the counseling acknowledgement information received from the digital desk server 200 to establish a video link between the counselor and the customer.

The second AP 300 may be, for example, an application installed in the counselor terminal 400, and the counselor may download the second AP 300 through an AP store. The second AP 300 may request a video link through the control unit 110 of the digital desk apparatus 100.

On the other hand, if the counseling request from the customer is out of the business hours, the counselor connection determination unit 500 may determine that counselor connection is not required and provide task types such that a list of tasks that can be processed without a counselor is displayed.

A list of tasks that can be processed without a counselor may be provided to the display unit 121 of the digital desk apparatus 100. The list of tasks that can be processed without a counselor may include, but is not limited to, account opening task, document application task, card issuance task, and the like that can be processed by customer input. A customer may input necessary information through the touch input unit 123 provided in the digital desk apparatus 100.

In addition, the list of tasks that can be processed without a counselor may include withdrawal task, deposit task, and account inquiry task, and the digital desk apparatus 100 and the ATM 700 may be connected to provide deposit or withdrawal services.

According to the embodiment, it is possible to improve the customer's task processing efficiency by controlling the task processing method differently depending on the business hours of a bank.

When a customer sits on a seat arranged in the digital desk apparatus 100 and requests counseling, the counselor connection determination unit 500 may determine whether the request for counseling is made within business hours or out of the business hours. At this time, even if it is determined that the time at which the customer requests counseling is within the business hours, it may be determined whether or not consultation with a counselor is required for banking requested by the customer. As a result, it is possible to perform the banking without a counselor during the business hours.

As shown in FIG. 3, upon determining that the customer's counseling request is within the business hours, the task controller 600 may display task types on the image display disposed in the digital desk apparatus 100 (S100).

The customer may select the type of a task to be processed with reference to the task types displayed on the digital desk apparatus 100.

The task controller 600 may receive a selection signal for the type of the task to be processed by the customer (S300).

The task controller 600 determines connection with a counselor based on the selection signal (S300).

The task controller 600 may send a request for a video link to the digital desk server 200 (S400). The digital desk server 200 may establish a video link between a counselor and the customer using the counselor terminal and the digital desk apparatus 100.

Upon determining that the customer's counseling request is out of the business hours, the task controller 600 may provide a signal to the image display of the digital desk apparatus 100 such that the image display displays a list of tasks that can be processed without a counselor.

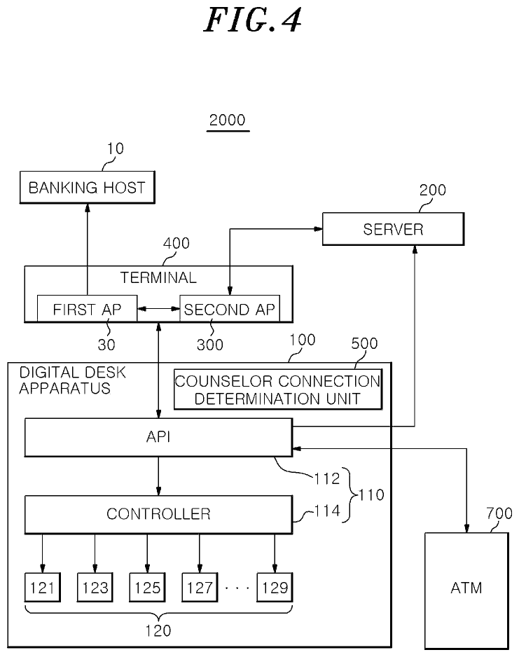

FIG. 4 is a block diagram showing a remote counseling service system according to a second embodiment.

Referring to FIG. 4, the remote counseling service system 2000 according to the second embodiment may include a CSR terminal 400 connected to a banking host 10, a digital desk apparatus 100 including a counselor connection determination unit 500, and a digital desk server 200. Here, since the operation of the digital desk server 200 is the same as that in the first embodiment, detailed description thereof will be omitted.

The counselor connection determination unit 500 may determine whether the time at which a customer requests counseling is within business hours or out of the business hours.

Upon determining that the time at which the customer requests counseling is within the business hours, the counselor connection determination unit 500 may transmit a signal for connection with a counselor to the digital desk server 200.

On the other hand, if the time at which the customer requests counseling is out of the business hours, the counselor connection determination unit 500 may determine that connection with a counselor is not necessary and provide task types such that a list of tasks that can be processed without a counselor is displayed.

The CSR terminal 400 may be connected to the banking host 10. The CSR terminal 400 may perform communication related to financial tasks from the banking host 10 under the control of a counselor. A first AP 30 is installed in the CSR terminal 400 to perform communication with the banking host 10.

The CSR terminal 400 may include a second AP. The second AP 300 may communicate with the first AP 30 to exchange information received from the digital desk apparatus 100. The second AP 300 may communicate with the digital desk server 200.

The second AP 300 may register data received from the digital desk apparatus 100 by directly accessing the banking host 10. That is, the second AP 300 may process some tasks processed by the first AP 30 instead of the first AP 30.

The digital desk apparatus 100 may include a control unit 110 and an output means 120. The controller 110 may include an application program interface (API) 112 and a controller 114. The API 112 may perform communication with the second AP 300. The API 112 may receive a video link request from the second AP 300. The controller 114 may establish a video link through the display unit 121 provided in the digital desk apparatus 100, for example, a monitor.

The output means 120 may include the display unit 121, a touch input unit 123, a scanner 125, a pin pad 127, a printer 129, and the like. The display unit 121 may include a monitor or a transparent display. The display unit 121 may be installed on the upper plate of the desk and disposed between a customer and a counselor.

The touch input unit 123 may receive touch information of a customer. The touch input unit 123 may receive touch information of a customer selected based on a screen on which financial information presented by a counselor is displayed.

The location where the touch input unit 123 is disposed is not limited, but it is effective to form the touch input unit 123 at a distance where a customer's hand can reach.

The scanner 125, the pin pad 127, and the printer 129 may be disposed on the desk D or one side thereof, and operations thereof may be controlled by the control unit 110.

The remote counseling service system according to the second embodiment has an effect of processing a customer's task more efficiently by directly accessing the banking host using the second AP.

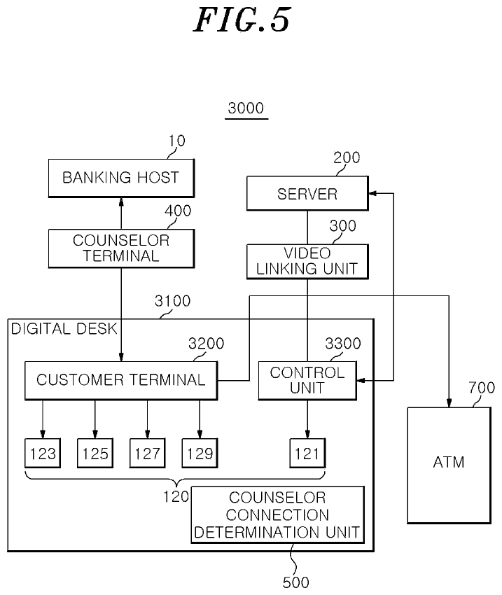

FIG. 5 is a block diagram showing a remote counseling service system according to a third embodiment.

Referring to FIG. 5, the remote counseling service system 3000 according to the third embodiment may include a CSR terminal 400 connected to a banking host 10, a digital desk 3100 including a counselor connection determination unit 500, and a digital desk server 200.

The CSR terminal 400 may be connected to the banking host 10. The CSR terminal 400 may perform tasks related to banking under the control of a counselor. The CSR terminal 400 may communicate with a customer terminal 3200. Here, the CSR terminal 400 may include a mobile phone, a tablet, a personal computer, and a laptop computer, but is not limited thereto.

The counselor connection determination unit 500 may determine whether a time at which a customer requests counseling is within business hours or out of the business hours.

Upon determining that the time at which the customer requests counseling is within the business hours, the counselor connection determination unit 500 may transmit a signal for connection with a counselor to the digital desk server 200.

On the other hand, if the time at which the customer requests counseling is out of the business hours, the counselor connection determination unit 500 may determine that connection with a counselor is not necessary and provide task types such that a list of tasks that can be processed without a counselor is displayed.

The digital desk server 200 may receive a customer's counseling request from a control unit 3300 of the digital desk apparatus 3100. When a customer requests counseling through the digital desk apparatus 3100, the digital desk server 200 may receive the customer's counseling request through the control unit 3300.

Upon reception of the customer's counseling request from the control unit 3300, the digital desk server 200 may transmit the counseling request to counselors who will process a task type suitable for the customer's counseling based on the contents of the customer's counseling. The digital desk server 200 may determine a plurality of counselors capable of processing the customer's task and transmit the counseling request to a plurality of counselor terminals 400.

In addition, the digital desk server 200 may determine a plurality of counselors capable of counseling based on task standby and a language as well as the customer's task type.

When counselors capable of consulting with the customer among the plurality of counselors transmit counseling acknowledgement information to the digital desk server 200 through their counselor terminals 400, the digital desk server 200 may determine a counselor who will consult with the customer based on the first received counseling acknowledgement information. The digital desk server 200 may transmit information on the counselor who will consult with the customer to a video linking unit 300.

The video linking unit 300 may control the terminal 400 of the counselor and an display unit 121 disposed on the digital desk apparatus 3100 based on the counseling acknowledgement information received from the digital desk server 200 to establish a video link between the counselor and the customer.

The digital desk device 3100 may include an output means 120. The output unit 120 may include the display unit 121, a touch input unit 123, a scanner 125, a pin pad 127, a printer 129, and the like. The display unit 121 may include a monitor or a transparent display. Two or more image displays 121 may be provided, and the number of image displays is not limited.

The touch input unit 123 may receive touch information of a customer. The touch input unit 123 may receive touch information of a customer selected based on a screen on which financial information presented by a counselor is displayed.

Among the output means 120, the display unit 121 may be operated by the control unit 3300, and operations of the touch input unit 123, the scanner 125, the pin pad 127, and the printer 129 may be controlled by a customer terminal 3200 disposed in the digital desk apparatus 3100.

While video counseling is in progress, the counselor may request data necessary for counseling from the customer terminal 3200 through the counselor terminal 400.

The customer terminal 3200 may transmit ID information, account information, PIN information, etc. input by controlling the touch input unit 123, the scanner 125, the pin pad 127, and the printer 129 to the counselor terminal 400.

The counselor may proceed with financial counseling using the data and input information of the customer and may terminate the transaction through the CSR terminal 400 upon completion of the financial counseling. The CSR terminal 400 may transmit transaction completion information to the digital desk server 200.

Since the remote counseling service system according to the third embodiment separately includes a device for controlling images, the remote counseling service system can be implemented more conveniently.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

Methods according to various embodiments disclosed in this document may be provided by being included in a computer program product.

According to one embodiment, a computer-readable recording medium storing a computer program may include instructions for causing a processor to perform a method including: determining whether a time at which a customer requests a banking service is within business hours of counselors; sending a request for consultation with a counselor to a digital desk server if the time is within the business hours as a result of the determination; and processing the banking service through a task automation process if the time is out of the business hours as a result of the determination.

According to one embodiment, a computer program stored in a computer-readable recording medium may include instructions for causing a processor to perform a method including: determining whether a time at which a customer requests a banking service is within business hours of counselors; sending a request for consultation with a counselor to a digital desk server if the time is within the business hours as a result of the determination; and processing the banking service through a task automation process if the time is out of the business hours as a result of the determination.

Although the present disclosure has been described above with reference to the drawings and embodiments, those skilled in the art can understand that the embodiments can be modified and changed in various ways without departing from the technical spirit of the embodiments described in the claims below.

1. A banking processing apparatus comprising:
an output unit including a display device;
an input unit configured to determine a user input by a user;
a memory; and
a processor executing one or more instructions stored in the memory, wherein the instructions, when executed by the processor, cause the processor to generate a first graphic user interface (GUI) for processing at least one banking service and output the first GUI on the output unit; determine whether the user input on the first GUI is occurred and determining a time at which the user input on the first GUI is occurred; establish session for a video call with a customer service representative (CSR) terminal and process the video call through the session, if the time at which the user input on the first GUI is occurred is within predetermined business hours; and a generate second GUI for processing at least one banking automation task and output the second GUI on the output unit, if the time at which the user input on the first GUI is occurred is out of the predetermined business hours.

2. The banking processing apparatus of claim 1, wherein the second GUI includes at least one menu corresponding to each of at least one banking automation task that is able to be processed without a customer service representative (CSR).

3. The banking processing apparatus of claim 2, wherein the at least one banking automation task includes at least one of account opening task, document application task, and card issuance task.

4. The banking processing apparatus of claim 1, wherein the processor is configured to communicate with an ATM (Automated Teller Machine), and control the ATM to perform the banking automation task requested by the user.

5. A banking processing method executed by a processor included in a banking processing apparatus, the method comprising:
generating a first graphic user interface (GUI) for processing at least one banking service and outputting the first GUI on an output unit including a display device;
determining whether a user input on the first GUI is occurred through an input unit configured to determine the user input by a user, and determining a time at which the user input on the first GUI is occurred;
establishing a session for a video call with a customer service representative (CSR) terminal and processing the video call through the session, if the time at which the user input on the first GUI is occurred is within predetermined business hours; and
generating a second GUI for processing at least one banking automation task and outputting the second GUI on the output unit, if the time at which the user input on the first GUI is occurred is out of the predetermined business hours.

6. The banking processing method of claim 5, wherein the first GUI includes at least one menu corresponding to the at least one banking service,
further comprising:
determining whether the at least one banking service corresponding to the at least one menu selected by the user is not required to consult with the CSR when the at least one menu corresponding to the at least one banking service is selected by the user; and
generating the second GUI for processing at least one banking automation task and outputting the second GUI on the output unit, if the at least one banking service corresponding to the at least one menu selected by the user is not required to consult with the CSR and the time at which the user input on the first GUI is occurred is within the predetermined business hours.

7. A remote counseling service system comprising:
a banking host;
a customer service representative (CSR) terminal connected to the banking host;
a digital desk apparatus including an output unit including a display device, an input unit configured to determine a user input by a user, a first memory; and a first processor,
wherein the first processor is configured to execute one or more instructions stored in the first memory, wherein the instructions, when executed by the first processor, cause the first processor to generate a first graphic user interface (GUI) for processing at least one banking service and output the first GUI on the output unit, determine whether the user input on the first GUI is occurred and determine a time at which the user input on the first GUI is occurred, determine whether the time at which the user input on the first GUI is occurred is within predetermined business hours, establish a session for a video call with the CSR terminal and process the video call through the session, and generate a second GUI for inputting a data requested by a CSR and display the second GUI on the output unit, and
a digital desk server including a second memory and a second processor,
wherein the second processor is configured to execute one or more instructions stored in the second memory, wherein the instructions, when executed by the second processor, cause the second processor to establish the session for the video call between the CSR terminal and the digital desk apparatus if the time at which the user input on the first GUI is occurred is within the predetermined business hours,
wherein the first processor of the digital desk apparatus is configured to generate a third GUI for processing at least one banking automation task and output the third GUI on the output unit, if the time at which the user input on the first GUI is occurred is out of the predetermined business hours.

8. The remote counseling service system of claim 7, wherein the second processor of the digital desk server is configured to:
transmit a counseling request message to the CSR terminals based on a type of the at least one banking service requested by the user,
receive a counseling response message from at least one of the CSR terminals, and
determine at least one of the CSR terminals to be connected to the digital desk apparatus based on a time at which the counseling response message is received.
